(19) United States
(12) Patent Application Publication
(10) Pub. No.: US 2014/0109089 A1
(43) Pub. Date: Apr. 17, 2014

(54) SYSTEM TO REBUILD DIFFERENCE VIRTUAL HARD DISK FOR UPDATING OPERATION SYSTEM AND METHOD THEREOF

(71) Applicants: INVENTEC (PUDONG) TECHNOLOGY CORPORATION, Shanghai (CN); INVENTEC CORPORATION, Taipei (TW)

(72) Inventor: Hong Su ZHANG, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/794,865

(22) Filed: Mar. 12, 2013

(30) Foreign Application Priority Data
Oct. 12, 2012 (CN) 201210388667.4

(51) Int. Cl. G06F 9/455

(52) U.S. Cl. CPC G06F 9/455
USPC 718/1

(57) ABSTRACT

A system to rebuild a difference virtual hard disk (VHD) for updating an operation system (OS) and a method thereof are provided. After a setting host updates a OS contained in a parent VHD, a service host uses the parent VHD as a base image to build a difference VHD. After the service host writes system setting data into the difference VHD, a virtual machine (VM) executed by the service host loads the updated OS. The updated OS executes the agent after startup so that the agent sets the operating environment according to the setting data. The system and the method need not to update OSes using the same base image respectively, and can achieve the effect of increasing the efficiency of updating the OS using the same base image, and decreasing network traffic when updating the OS.

### BACKGROUND OF THE INVENTION

1. Field of Invention

The invention relates to an updating system of an operating system (OS) and the method thereof. In particular, the invention relates to a system to rebuild the difference virtual hard disk (VHD) for updating an OS and the method thereof.

2. Related Art

Users doing same work usually use exactly the same operating environment. For the convenience of management, as well as to avoid the need to install the operating system (OS) and applications individually for each user, one often adopts the virtual machine (VM) solution nowadays. The administrator first installs an OS and necessary applications as the initial operating environment, which is used as the base image of the user's VM. The VM then mounts the difference disk established based on the base image. Therefore, the administrator only installs the operating environment once. All the VM's can share the OS and applications in the base image.

Since the shared base image of the VM's is read-only, to update the OS running in the VM's, one has to update them individually. However, the user of the OS running in the individual VM usually does not have the privilege to update the OS. Therefore, the administrator has to log into the VM one by one to update the OS. This costs a lot of time and effort when there are a lot of VM's.

According to the current technology, when there is an OS patch for upgrade, one has to push all files that need to be updated according to a predetermined scenario at specific time. In this case, multiple VM's download the update patch simultaneously. This inevitably increases network traffic and thus lowers the update efficiency.

In summary, the prior art always has the problem that the administrator needs to update one by one the OS running on VM's that share the same base image. It is therefore imperative to provide a better solution.

### SUMMARY OF THE INVENTION

In view of the foregoing, the invention discloses a system to rebuild the difference VHD file for updating an OS and the method thereof.

The disclosed system includes: a managing server for storing the parent VHD file and system setup data, with the parent VHD file including an OS; a setting host for updating the OS; a domain server for storing personalized data before the OS update; a service host for using the parent VHD file after the OS update as the base image to establish the difference VHD file, obtaining system setup data from the managing server and writing the system setup data into the difference VHD file, and executing the VM corresponding to the difference VHD file to load the OS. The OS executes an agent. After the agent sets up the operating environment of the OS according to the system setup data and the OS has been logged in, the agent obtains the personalized data from the domain server through the service host.

The disclosed method includes the steps of: using a setting host to update the OS in a parent VHD file stored in a managing server; using a service host to use the parent VHD file after the OS update as the base image to establish a difference VHD file; using the service host to obtain system setup data of the OS of the managing server; using the service host to write the system setup data to the difference VHD file; using the service host to execute the VM corresponding to the difference VHD file to load the OS; letting the OS to execute the agent; when the agent sets up the operating environment of the OS according to the system setup data and the OS has been logged in, letting the OS to obtain personalized data before the update from the domain server.

The disclosed system and method differ from the prior art in that the invention uses the setting host to update the OS contained in the parent VHD file. Afterwards, the service host uses the parent VHD file after the OS update as the base image to establish the difference VHD file. After the system setup data are written into the difference VHD file, a VM is executed to load the updated OS. The updated OS executes the agent after startup so that the agent can set up the operating environment of the OS according to the system setup data. Not only does the invention solve the problems in the prior art, it also increases the efficiency of updating the OS running in VM's that share a base image and reduces the network traffic required for downloading the update patches.

### BRIEF DESCRIPTION OF THE DRAWINGS

The invention will become more fully understood from the detailed description given herein below illustration only, and thus is not limitative of the present invention, and wherein:

FIG. 1 shows the structure of the system to rebuild the difference VHD file for updating the OS.

FIG. 2A is a flowchart for the method to rebuild the difference VHD file for updating the OS.

FIG. 2B is a flowchart for the method of updating the OS contained in the parent VHD file.

FIG. 2C is a flowchart for the method that the managing server provides the information about whether the OS can be logged in.

### DETAILED DESCRIPTION OF THE INVENTION

The present invention will be apparent from the following detailed description, which proceeds with reference to the accompanying drawings, wherein the same references relate to the same elements.

The invention can be employed to update the OS contained in a parent VHD file and to use the parent VHD file as the base image to establish a difference VHD file. The VM mounted with the difference VHD file can load the updated OS. At the same time, the invention can set user's personalized data in the OS before the update in a server. Therefore, it maintains the integrity of the personalized data after the OS update without losing them.

The personalized data referred herein include all user's setting files in the OS, redirecting directory of users in the OS, and so on. The invention is not limited to these examples. The redirecting directory can save application data produced by applications in the OS.

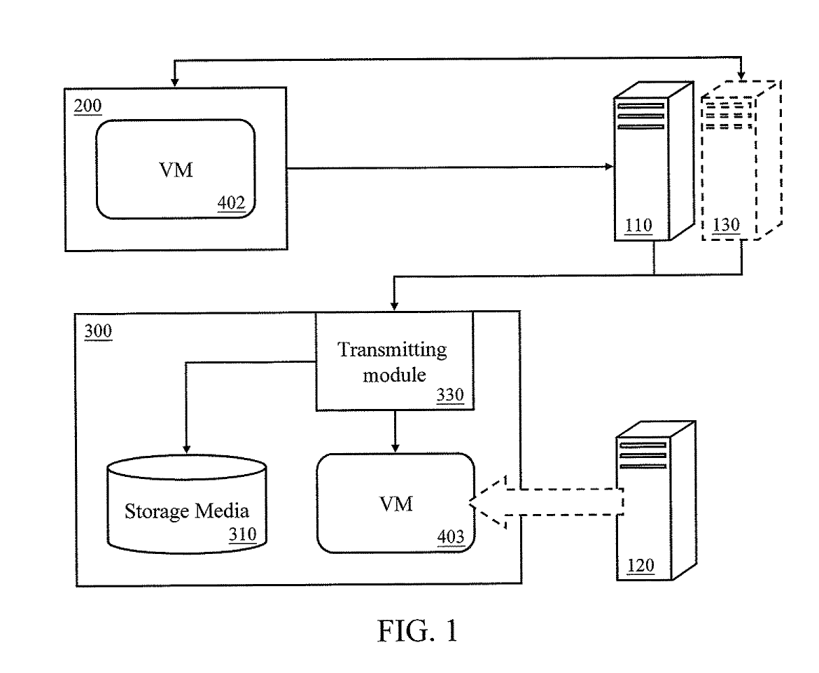

FIG. 1 shows the structure of the disclosed system to rebuild the difference VHD file for updating the OS. As shown in the drawing, the system includes a managing server 110, a domain server 120, a setting host 200, and at least one service host 300. The service host 300 further includes a storage media 310, a transmitting module 330, and a VM 403 executed by the service host 300.

The managing server 110 manages the parent VHD file that includes an OS. The format of the parent VHD file is either fixed or dynamic. In general, the parent VHD file managed by the managing server 110 is stored in a storage server 130. However, the invention is not limited to such a possibility. In some embodiments, the managing server 110 also has the function of the storage server 130 to store the parent VHD file. For convenience in the description of the specification, we use the managing server 110 and the storage server 130 to manage and store the parent VHD file, respectively.

The managing server 110 can read such file information as establishing date and size of the parent VHD file stored in the storage server 130, and establish the version information corresponding to each of the parent VHD files, thereby managing the parent VHD files stored in the server. However, the invention is not limited to this case.

In some embodiments, the managing server 110 may manage several parent VHD files of different versions. Each of the parent VHD files has a distinct OS version. That is, each time the OS is updated, the parent VHD file containing the updated OS is stored by the storage server as a new version.

The managing server 110 also manages the system setup data corresponding to the VM 403 executed by the service host 300. The system setup data managed by the managing server 110 are those data that differ between any two OS's, such as the computer name, domain access privilege, user's security identifier (SID), user's privilege, etc. However, the invention is not restricted to such examples. Besides, the managing server 110 also stores the system setup data it manages. Again, the invention is not limited to this possibility. For example, the system setup data can be stored in the storage server 130 as well.

The domain server 120 sets the storage paths of the personalized data of all users in the OS. That is, it provides the functions of setting the roaming paths of user's setting files and the location paths of the redirecting directories. The roaming path and the local path of the redirecting directory referred here point to the directories shared by specific servers on the network, such as the shared directories of the storage server or domain server 120.

Generally speaking, the domain server 120 enables the setting host 200, service host 300, or the OS running in the VM 403 to set the storage paths of the personalized data of specific users in the OS. However, the invention does not put a restriction on this.

The setting host 200 updates the OS contained in the parent VHD file. The setting host 200 downloads the parent VHD file from the storage server 130 and saves it to the hard disk thereof, and then executes the VM 402 so that the VM 402 mounts the parent VHD file copied to the setting host 200. If the setting host 200 stores the same VHD file as the parent VHD file managed by the managing server 110, the setting host 200 can directly execute the VM 402 so that the VM 402 mounts the VHD file stored in the setting host 200. Generally speaking, the setting host 200 runs the VM 402 in the setting host 200. While running, the VM 402 mounts the parent VHD file, thereby generating a VHD installed with the OS contained in the parent VHD file. The VM 402 then uses the generated VHD file to load the OS while starting up.

When the OS running in the VM 402 is updated, the VHD installed with the OS in the VM 402 is accessed. That is, the parent VHD file copied to the host 200 is accessed. After the OS is updated, the parent VHD file copied to the setting host 200 contains the updated OS. After the VM 402 finishes running or unmounts the parent VHD file, the setting host 200 uploads the parent VHD file containing the updated OS to the storage server 130 that stores the parent VHD file. Therefore, the managing server 110 obtains the file and version information of the uploaded parent VHD file.

After the OS loaded from the VM 402 completes the startup, the setting host 200 sets to update the OS. After the OS update is completed, the updated OS is further set to execute the agent during the next startup.

In fact, the setting host 200 can directly execute the VM 402 without downloading the parent VHD file in the storage server 130. The VM 402 mounts the parent VHD file stored in the storage server 130 through the network. When the OS running the VM 402 is being updated, the VHD installed with the OS in the VM 402 is accessed. That is, the parent VHD file stored in the storage server 130 is accessed. After the OS is updated, the parent VHD file in the storage server 130 contains the updated OS. The managing server 110 obtains again the file and version information of the updated parent VHD file.

The setting host 200 can set in the registry of the updated OS that during the next startup of the OS, the system automatically logs into the OS as the administrator to run the agent once or automatically runs the agent once under the identity of the administrator in the background. However, the method used by the setting host to execute the agent once during the next startup of the updated OS is not limited to these examples.

Besides, the setting host 200 also determines whether the VHD mounted in the VM 402 stores the agent, i.e., determines whether the parent VHD file contains the agent. If not, the setting host 200 downloads the agent from the storage server 130 and saves the agent to the VHD mounted in the VM 402, i.e., writes the agent to the parent VHD file.

The service host 300 obtains the system setup data corresponding to the VM 403 from the managing server 110 through the transmitting module 330. The parent VHD file of the updated OS is used as the base image to establish in the storage media 310 a current VHD file corresponding to the VM 403 executed by the service host 300. The established current VHD file is written with the obtained system setup data corresponding to the VM 403. The current VHD file is mounted so that the service host 300 generates a VHD.

The storage server or the managing server 110 may store several parent VHD files of different versions. In some embodiments, the service host 300 can select one parent VHD file from the multiple parent VHD files managed by the managing server 110, and use it as the base image to establish a difference VHD file.

The service host 300 also executes the VM 403. According to the invention, each of the service hosts 300 can run one or multiple VM's 403, each of which corresponds to a difference VHD file.

After the service host 300 runs the VM 403, the OS running on the VM 403 allows users to log in. The user can operate the service host 300 and logs into the OS running on the VM 403 via the service host 300. The user can also remotely log into the OS running on the VM 403 executed on the service host 300.

After being executed by the service host 300, the VM 403 mounts the corresponding difference VHD file, thereby generating the VHD in the VM 403. Since the difference VHD file is established using the parent VHD file as the base image and the parent VHD file contains the updated OS, the VHD generated by the VM 403 is installed with the updated OS. Therefore, the VM 403 can load the OS installed in the VHD, thereby starting up and providing the updated OS.

The updated OS is set by the setting host 200 to run the agent in the parent VHD file once during the next startup. Therefore, after the OS running the VM 403 finishes the startup, it follows the setting in the setting host 200 to automatically log into the OS as the administrator and run the agent, or to run the agent as the administrator in the background of the OS.

After the agent sets the operating environment of the OS according to the system setup data written by the service host 300 into the difference VHD, the OS running in the VM 403 allows a user to log in. When being logged in, the OS running in the VM 403 connects to the domain server 120 to obtain the storage path of the personalized data set by the domain server 120 and to obtain the personalized data from the shared directory of a specific server according to the storage path. For example, the user's setting file is downloaded from the domain server 120 or the storage server 130. It also connects to the redirecting directory provided by the domain server 120 or the storage server 130. As a result, after the OS running in the VM 403 is updated, the user's personalized data are still the same as before, without any effect from the OS update.

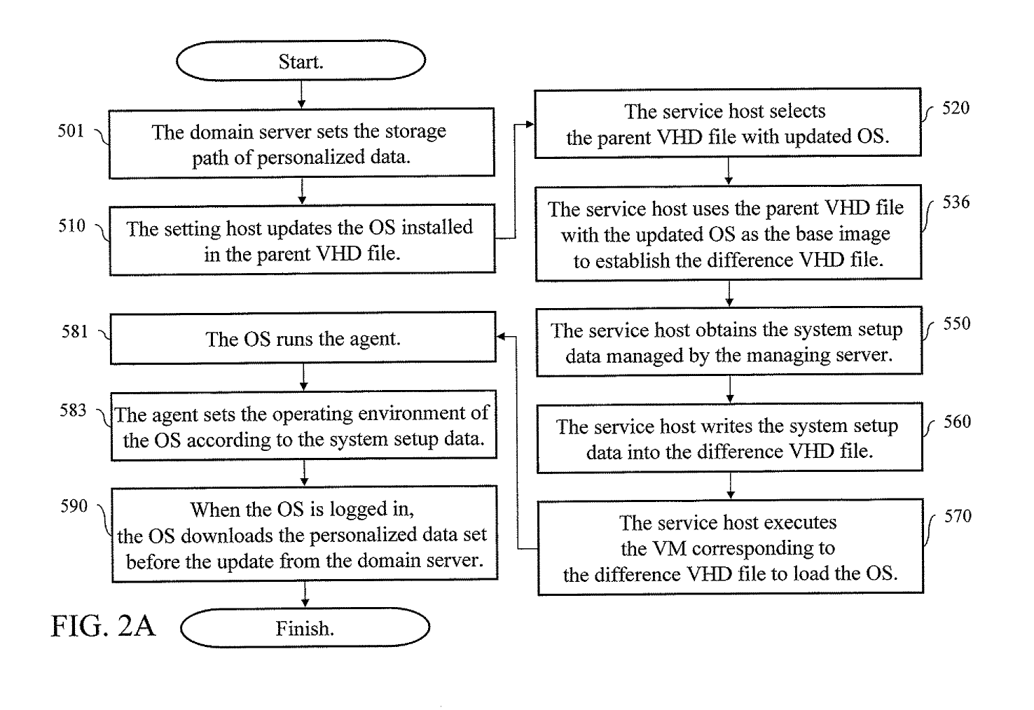

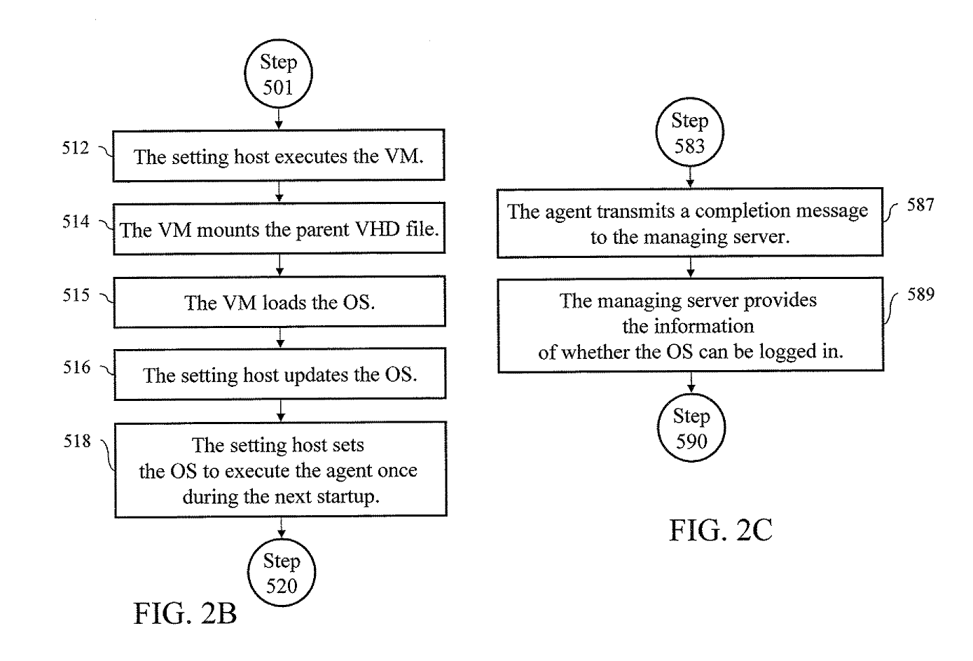

In the following, one embodiment is used to explain the disclosed system and method. Please refer to FIG. 2A for a flowchart of the method to rebuild the difference VHD file for updating the OS. In this embodiment, there are several service hosts 300.

When the VM 403 executed by each of the service hosts 300 is established, the domain server 120 needs to set the storage path of user's personalized data of the OS running in the VM 403 (step 501).

When the OS running in the VM 403 executed by the service host 300 needs an update, the user can operate the OS running in the VM 403 to achieve it so that the setting host 200 can update the OS contained in the parent VHD file (step 510). Suppose as in FIG. 2B that in this embodiment, after connecting to the storage server 130 to download the parent VHD file to the storage media thereof, the setting host 200 executes the VM 402 (step 512). After the VM 402 starts running, it can mount the parent VHD file contained in the storage media of the setting host 200 (step 514), thereby generating a VHD installed with the OS contained in the parent VHD file in the VM 402. That is, a VHD installed with the OS running in the VM 402 is generated. Then the VM 402 can load the OS from the generated VHD (step 515) to start up.

After the OS loaded by the VM 402 completes the startup, the setting host 200 starts the update of the OS running in the VM 402 (step 516). The OS running in the VM 402 installs the update file to the VHD thereof. That is, the OS contained in the parent VHD file downloaded by the setting host 200 is updated.

After the OS running in the VM 402 completes the update, the setting host 200 can further set so that the updated OS runs the agent once during the next startup (step 518). In this embodiment, the setting host 200 sets in the registry of the OS that the updated OS automatically executes the agent once as the administrator after the next startup is completed.

After the setting host 200 sets the updated OS to run the agent once after the next startup (step 518), the setting host 200 uploads the parent VHD file stored in the storage media to the storage server 130 that downloads the parent VHD file. Since the update of the OS running in the VM 402 is reflected in the parent VHD file stored in the storage media of the setting host 200, the parent VHD file stored the storage media of the setting host 200 contains the updated OS. That is, the setting host 200 uploads the parent VHD file containing the updated OS to the storage server 130 for storage. In the parent VHD file managed by the managing server 110, a description about the process of updating the parent VHD file is added. This completes the update of the OS contained in the parent VHD file (step 510).

Afterwards, when the user of the VM 403 executed by the service host 300 discovers that the parent VHD file managed by the managing server 110 (the parent VHD file stored in the storage server 130) contains the parent VHD file with the updated OS, he or she can operate the service host 300 to select the parent VHD file containing the updated OS (step 520), thereby updating the OS running in the VM 403.

In practice, the service host 300 can also connect to the managing server 110 to determine whether the managing server 110 stores the parent VHD file containing the updated OS. If so, the parent VHD file containing the updated OS is selected (step 520) to update the OS running in the VM 403. In this embodiment, the service host 300 can use the creation date or version of the filename of the parent VHD file stored in the managing directory of the managing server 110 to determine whether the storage server 130 stores the parent VHD file containing the updated OS.

When the service host 300 updates the OS running in the VM 403 thereof, the service host 300 first deletes the originally used difference VHD file. It then uses the parent VHD file containing the updated OS as the base image to establish a new difference VHD file in the storage media 310 (step 536).

Besides, the service host 300 also obtains the system setup data corresponding to the VM 403 and managed by the managing server 110 (step 550). In this embodiment, the system setup data obtained by the service host 300 contain such data as computer name, domain access privilege, user's security identity, and user's privilege in the OS running in the VM 403.

After using the parent VHD file containing the updated OS as the base image to establish a new difference VHD file in the storage media 310 (step 536) and obtaining the system setup data corresponding to the VM 403 and managed by the managing server 110 (step 550), the service host 300 can write the system setup data into the established difference VHD file (step 560). In this embodiment, the service host 300 uses the tool ‘diskpart’ to mount the difference VHD file, thereby generating the VHD in the service host 300. Afterwards, the service host 300 writes the system setup data into the generated VHD, i.e., the difference VHD file. After the service host 300 finishes the writing of the system setup data, it can unmount the difference VHD file.

After writing the system setup data into the established difference VHD file (step 560), the service host 300 can execute the VM 403 corresponding to the difference VHD file written with the system setup data (step 570).

After the VM 403 is executed by the service host 300, the VM 403 can mount the corresponding difference VHD file. After mounting the difference VHD file, the VM 403 generates the VHD. Since the difference VHD file is established using the parent VHD file as the base image, the VHD generated on the VM 403 is installed with the updated OS and stores the system setup data written by the agent and the service host 300.

After mounting the difference VHD file and generating the VHD, the VM 403 can load the updated OS to perform the startup procedure. After the updated OS completes the startup, the updated OS is set by the setting host 200 to run the agent once during the next startup (step 518). Therefore, the updated OS follows the setting of the setting host 200 to run the agent (step 581). In this embodiment, the updated OS is assumed to use the system administrator's account name and password to run the agent in the background.

When the agent is executed by the updated OS, it follows the system setup data written by the service host 300 in the difference VHD file to set the operating environment of the OS (step 587). In this embodiment, the agent sets the computer name, domain access privilege, user's security identity, and user's privilege in the updated OS.

After the agent follows the system setup data written by the service host 300 in the difference VHD file to set the operating environment of the OS (step 587), the user can log into the updated OS. In this embodiment, the user uses a remote desktop program to connect to the VM 403 of the service host 300 through the network. After entering the account name and password, the user remotely logs into the updated OS running in the VM 403.

After the user logs into the updated OS, the updated OS connects to the domain server 120 to obtain the storage path of the personalized data therein (step 590). In this embodiment, the updated OS uses the roaming directory set by the domain server 120, such as ‘\netuser profiles\’, to download the user's setting file uploaded before the OS update from the shared directory ‘netuser profiles’ of the storage server. The updated OS further links the directory holding the application data to the redirecting directory set by the domain server 120, such as the shared directory ‘\netuser rediredt\’ of the storage server. Therefore, after the OS running in the VM 403 is updated, the user's personalized data are still the same as before, without being affected by the update.

In the above-mentioned embodiment, after setting the operating environment of the updated OS according to the system setup data (step 583), the agent transmits a completion message to the managing server 110 (step 587), as shown in FIG. 2C. After receiving the completion message, the managing server 110 changes the status of the OS of the agent that transmits the completion message from not allowed to log in to allow to log in, thereby providing the information of whether the OS of the agent that sends the completion message can be logged in (step 589). The user can connect to the managing server 110 to check whether he or she can log into the OS.

When the OS running in the VM 403 of the service host 300 needs an update, the user using the OS needs to log out of the VM 403 and shut down the VM 403. In this case, the OS running in the VM 403 follows the storage path of the personalized data set in the domain server 120 to synchronize the user's personal data to the storage path set by the domain server 120. In this embodiment, the OS running in the VM 403 uses the roaming path ‘\\netcomputer\user profiles\’ set by the domain server 120. The OS running the VM 403 uploads the user's setting file to the shared directory ‘user profiles\’ of the storage server named ‘netcomputer’ for storage. Before the user logs out of the OS running in the VM 403, the application data generated by the application running by the OS of the VM 403 are stored by the OS running in the VM 403 to the redirecting directory ‘\user redirect\’ set by the domain server 120, i.e., to the directory ‘\user redirect\’ of the storage server.

Although the invention may include several service hosts 300 and each service host can run one or multiple VM's, the updating process for the OS running in each of the VM's is exactly the same as described above. Therefore, using the invention, the OS running in the VM mounted with the parent VHD file is not individually updated. One simply updates the OS contained in the parent VHD file.

In summary, the invention differs from the prior art in that after the setting host update the OS contained in the parent VHD file, the service host uses the parent VHD file with the updated OS as the base image to establish the difference VHD file. After the system setup data are written into the difference VHD file, the VM is executed to load the updated OS. The updated OS executes the agent after the startup so that the agent follows the system setup data to set the operating environment of the OS. This technique solves the problem in the prior art that the OS's running in the VM's that share a base image have to individually updated. This achieves the goals of increasing the efficiency in updating the OS's running in the VM's that share a base image and reducing the network traffic required for downloading the update patches.

Furthermore, the disclosed system and method to rebuild the difference VHD file for updating the OS can be implemented in software, hardware, and the combination thereof. It can be implemented in a centralized way among computer systems or in a distributed way among several interconnected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of rebuilding a difference virtual hard disk (VHD) file for updating an operating system (OS), comprising the steps of:
using a setting host to update an OS contained in a parent VHD file stored in a managing server;
using a service host to use the parent VHD file with the updated OS as the base image to establish a difference VHD file;
letting the service host obtain system setup data managed by the managing server;
letting the service host write the system setup data to the difference VHD file;
letting the service host execute a virtual machine (VM) corresponding to the difference VHD file, with the VM loading the OS;
letting the OS execute an agent; and
after the agent follows the system setup data to set the operating environment of the OS and the OS is logged in, letting the OS obtain personalized data set before the update from a domain server.

2. The method of claim 1, wherein the step of using a setting host to update an OS contained in a parent VHD file includes the steps of: letting the setting host execute another VM; after the VM executed by the setting host mounts the parent VHD file and loads the OS, letting the VM executed by the setting host update the OS; and executing the agent only once before loading the OS in the next time.

3. The method of claim 1, wherein the step of the OS being logged in is preceded with the step of letting the domain server set a storage path of the personalized data.

4. The method of claim 1, wherein the step of after the agent follows the system setup data to set the operating environment of the OS is followed by the step of letting the agent transmit a completion message to the managing server so that the managing server provides information of whether the OS is allowed for login.

5. The method of claim 1, wherein the step of using a service host to use the parent VHD file with the updated OS as the base image to establish a difference VHD file is preceded with the step of letting the service host to select one of the parent VHD files with the updated OS as the base image.

6. A system of rebuilding a difference VHD for updating an OS, comprising:
a managing server for managing at least one parent VHD file and system setup data, with the parent VHD file containing an OS;
a setting host for updating the OS;
a domain server for setting a storage path of personalized data before the OS update; and
a service host for after using the parent VHD file after the OS update as the base image to establish a difference VHD, obtaining the system setup data managed by the managing server and writing the system setup data to the difference VHD file, and for running a VM corresponding to the difference VHD file to load the OS;
wherein the OS runs an agent; after the agent sets the operating environment of the OS according to the system setup data and when the OS is logged in, the agent obtains the personalized data from the domain server through the service host.

7. The system of claim 6, wherein the setting host executes another VM; and after the VM executed by the setting host mounts the parent VHD file and loads the OS, the VM updates the OS and sets to execute the agent only once before loading the OS in next time.

8. The system of claim 6, wherein the agent further transmits a completion message to the managing server so that the managing server provides whether the OS is allowed to log in.

9. The system of claim 6, wherein the service host selects one of the parent VHD files with the updated OS for the service host to use as the base image.
